(19) United States
(12) Patent Application Publication
(10) Pub. No.: US 2012/0005144 A1
(43) Pub. Date: Jan. 5, 2012

(54) OPTIMIZATION OF RULE ENTITIES

(75) Inventors: Kevin Scott Cutler, Carp (CA); Felix Katz, Ottawa (CA); Katha Kulasingam, Ottawa (CA)

(73) Assignee: Alcatel-Lucent Canada, Inc., Ottawa (CA)

(21) Appl. No.: 12/827,843

(22) Filed: Jun. 30, 2010

(51) Int. Cl. G06N 5/02

(52) U.S. Cl. 706/47; 706/59

(57) ABSTRACT

A method of optimizing a rules engine rule set is disclosed. The method provides for identifying groups of rule conditions within a rule table that are repetitive; determining a hash function that will effectively summarize in a condensed form the set of criteria, operations and values that distinguish the group for each respective group of the identified groups; calculating hash values per the hash functions for each row of the rule table; storing the derived hash functions, the calculated hash values, and the original rule in memory when loading; and then at run time when the rule engine is invoked: calculating the hash values using the respective hash functions associated with the rule table using the attributes provided at invocation; and skipping all rows whose hash values are different from the calculated invocation hash values. The method of optimizing rule entities is particularly useful for overcoming the longer calculation times associated with un-optimized rule tables known in the art.

### FIELD OF THE INVENTION

The invention relates to a method and apparatus for producing a more optimized set of decision trees to be used in a rule engine, wherein the decision trees are derived from an initial rules database.

### BACKGROUND OF THE INVENTION

As demand increases for varying types of applications within mobile telecommunications networks, service providers constantly upgrade their systems in order to reliably provide an expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit-switched core, while other service communications are transmitted according to the Internet protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “long term evolution” (LTE). In an LTE network, all communications are carried over an IP channel from user equipment (UE) to an all-IP core called the evolved packet core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, and 3GPP TS 29.214 describe the policy and charging rules function (PCRF), policy and charging enforcement function (PCEF), and bearer binding and event reporting function (BBERF) of the EPC. These specifications further provide some guidance as to how these elements interact in order to provide reliable data services and charge subscribers for use thereof.

For example, 3GPP TS 29.212 and 3GPP TS 29.214 provide some guidance on the establishment of an application session by the EPC upon receipt of an application request from an application function (AF) in the form of an aa-request (AAR) message or from a packet data network gateway (PGW) in the form of a credit control request (CCR) message. The standards specify that the PCRF is responsible for receiving requests, establishing IP-CAN and gateway control sessions, creating new policy and charging control (PCC) rules commensurate with such requests, and providing these new PCC rules to the PCEF for installation. The 3GPP standards also define the format of various messages and PCC rules.

The main objective of the PCRF is to provide QoS information about an IP-CAN (default bearer QoS) or explicit application session (dedicated bearer). Standards and sound engineering practices dictates a default mapping which is outlined in the 3GPP architecture but it is often overridden by business requirements or regulatory constraints.

One method of doing this is to map an application request in the traffic policy to be pushed to the PCEF (PGW or GGSN). The logic behind this mapping is implemented in a rules engine, which can be modified by the introduction of a new rule (that is, if condition, then action). A rules engine can implement an event-driven forward-chaining rule evaluation algorithm using production style rules with flexible interconnects to external decision points.

In one such version of a rules engine, rules are in a simple “Condition and Action” format where conditions can be described using PCRF parameters and the attributes that are communicated with:
SPR (via Sp)
PCEF (via Gx or Gxx)
AF (via Rx)
internal session state

These rules may be established by default rule sets originally associated with the network equipment, or alternative rules defined by network operators for purposes specific to the network.

In order to apply the rules stored in the rules database, the rule structure must be placed in decision tree form for application by the rules engine.

A simple mapping of rules onto decision trees can lead to redundant assessment of similar decisions, thereby slowing down execution of the rules engine.

Therefore it would be useful to have some means to optimize the set of decision trees derived from the rule set in the database, so as to better apply the rules in a real-time setting.

### SUMMARY OF THE INVENTION

It is an object of the invention to provide a method for providing a more optimized set of decision trees from a rules database than would result were the rules directly translated into decision trees.

According to an aspect of the invention there is provided a method for accelerating the evaluation of rule tables within the compiled rule base for a rule engine; the method having the steps of: identifying groups of repetitive rule conditions within a rule table within the rule base; determining a first hash function which distinguishes the groups of rule conditions; calculating respective hash values per the first hash function for each rule of the rule table; storing the first hash function in the compiled rule base; storing the respective hash values in the compiled rule base; and storing the rule tables in the compiled rule base.

Advantageously, the method can include the further steps of when the rule engine is invoked to determine at least one action for a set of attributes, calculating the hash value for the set of attributes; and skipping evaluation of those rows in the rule tables whose respective hash values are different than the hash value for the set of attributes.

According to another embodiment of the invention, there may be the additional steps of: determining at least one additional hash function which further distinguishes the groups of rule conditions; and using the at least one additional hash function in the calculation and the storing steps.

Advantageously, when the rule engine is invoked to determine at least one action for a set of attributes, the additional steps of calculating a first hash value for the set of attributes according to the first hash function; calculating a second hash value for the set of attributes according to the at least one additional hash function; and skipping evaluation of those rows in the rule tables whose respective hash values are different than the respective hash values for the set of attributes may be applied.

According to yet another embodiment of the invention, the determining step further includes a compile-time optimization for choosing the first hash function. This compile-time optimization may include at least one of a criteria presence optimization, a mutually exclusivity optimization, a quantity of criteria used by the first hash function optimization, a type of criteria used by the first hash function optimization, a rule table length optimization, or a multi rule table optimization.

According to yet a further embodiment of the invention, the determining step further includes a post run-time optimization for choosing the first hash function. This post-run time optimization may include an optimization which contrasts a compiled rule base without the first hash function to a compiled rule base with the first hash function, or it may include an optimization which contrasts a plurality of the first hash functions.

Advantageously, in some embodiments the determining steps further include a compile-time optimization for choosing the first hash function and the at least one additional hash function, and in other embodiments further include a post run-time optimization.

### BRIEF DESCRIPTION OF THE DRAWINGS

The present invention will be further understood from the following detailed description of embodiments of the invention, with reference to the drawings in which:

FIG. 1 illustrates a functional sequence diagram for application of rules according to an embodiment of the present invention; and

FIG. 2 illustrates a functional block diagram for a rule engine in accordance with an embodiment of the present invention.

### DETAILED DESCRIPTION

According to an embodiment of the invention a rules optimization method is performed at rule compilation time. In order to appreciate the benefits of the optimization method, it is necessary to understand the nature of the rules and how they are stored in the system.

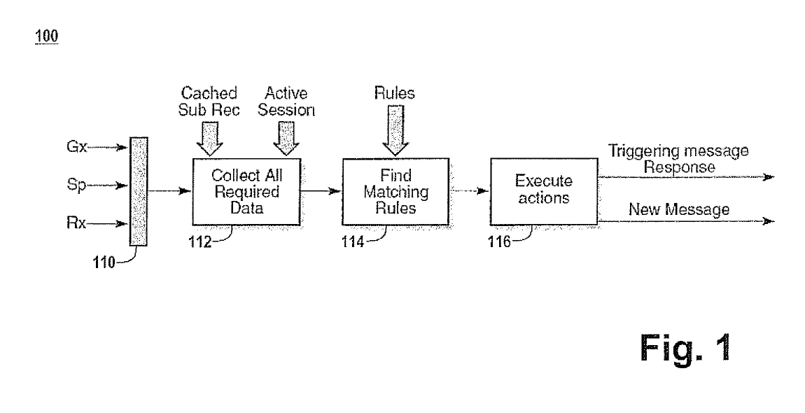

Referring to FIG. 1 there may be seen a functional sequence diagram 100 for application of rules according to an embodiment of the present invention.

The rule engine is invoked as part of external message handling interface 110:
Gx or Gxx message from the SGW
SP message from the SPR
Rx message from the AF

When invoked, the rule engine parses 112 all of the available data, such as:
Data within the incoming message, such as the content of Gx or Gxx CCR
Subscriber record, which is cached or retrieved from the SPR
Existing IPCAN session information, if available
Application Function session, if available
Gateway Control Session, if available
System data

The rule engine selects 114 the rules from the rules repository that match the incoming data.

The rule engine accepts or rejects the incoming request and constructs 116 a response message. Each rule determines the value of one of the parameters used in the response or used in triggering a new message

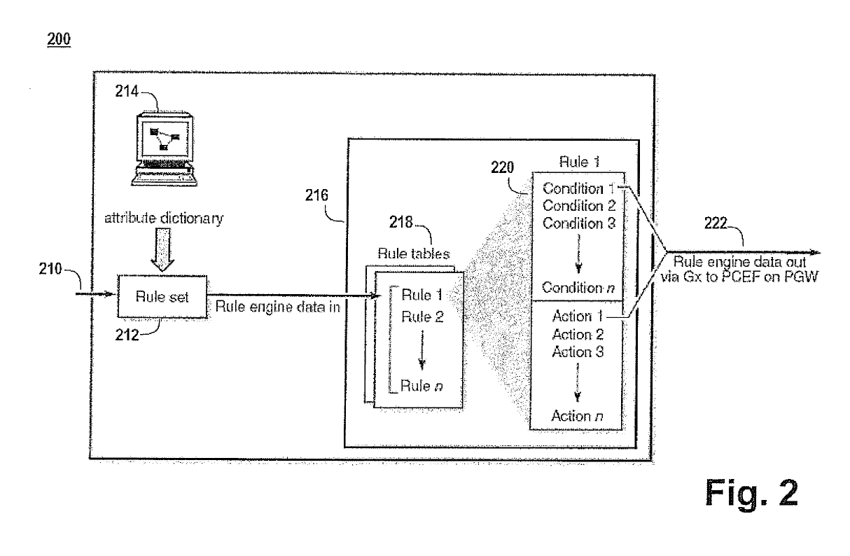

Referring to FIG. 2 there may be seen a functional block diagram for a rule engine according to an embodiment of the present invention. Each functional block is described in the sections that follow.

Rule Attribute Dictionary

The Rule attribute dictionary 214 lists all of the attributes that the rule engine 216 can manipulate. The Rule attribute dictionary 214 defines what attributes are available for creating a Policy Rule, in what context they are used, and the direction of the attribute. For example: for an attribute that moves in, this is used as a condition. For an attribute that moves out, this is used as an action.

Rule Definitions

A rule definition is a template that is used to define and create the PCRF rules. A rule definition consists of three parts:
rule definition name
applicable criteria—the context and the criteria
applicable action names—the predefined name of the action to apply in the specified context

Rule Sets

A rule set is a predefined list of operations in which policy rules can be executed. In general, policy rules are organized into groups called rule sets that are used to separate the rule base into smaller rule groups to improve processing speed and efficiency. As message processing flows are executed, specific rule sets are invoked.

For example, an IP_CAN_SESSION_ESTABLISHMENT rule set may be invoked when the rule engine processes a Gx CCR or Gxx CCR message for initial session establishment. According to one embodiment of the invention, all rule sets are predefined. Contents of the rule sets may be defined and redefined, but rule sets cannot be created or deleted.

Some rule sets control when the rule engine is triggered during the processing of a service; others define trigger points for message handling on the Gx, Gxx, Rx, and Sh interfaces 210. Example rule sets include;
IP-CAN session establishment, modification, and termination
GWC establishment, modification, and termination
AF session establishment, modification, and termination
SPR notification updates and deletions

Rule Tables

A rule table 218 is a rule set building block that can belong to one or more rule sets. It consists of a rule table definition and zero or more rule instances. The rule table definition defines a template for conditions and actions 220 that are used for all rule instances belonging to the rule table and is created based on the contents of the Rule attribute dictionary 214.

According to an embodiment of the invention, rule tables are evaluated based on the precedence of the rule instances. The first matched rule instance is executed and the result added to the list of results 222 for the rule set. It is possible for a rule table to be evaluated and have no matching rules.

For example, a rule table could be created to determine the Bearer Control Mode and be associated to the IP_CAN_SESSION_ESTABLISHMENT rule set.

A rule table is a set (instance) of PCRF rules that is grouped under the same rule definition. Rule tables can be used in one or more rule sets to maximize the policy rule optimization and consistency across different operations.

Policy Rules

A policy rule is an instance of a rule definition and belongs to a particular rule table. It is comprised of a set of rule conditions and rule actions. Each policy rule instance is created with a precedence that is unique in the context of the rule table. Rule conditions are only executed if all of the conditions are met.

Rule Conditions

Rule conditions are logical operations performed on an attribute from the rules attribute dictionary 214. Conditions are composed of the following parts:
criteria—represents the attribute to perform the action on
operator—represents the type of comparison to perform, such as equal, not equal
value type—depends on the attribute definition, and can be an integer, string, or enum
value—the value to use in the comparison

The condition represents the “if” statement in the processing logic and results in an evaluation of true or false; if an incoming message matches the condition (or conditions) the evaluation is true. Rule conditions are taken from the Rule attribute dictionary 214 and can come from a variety of source contexts including diameter messages, established sessions, and subscriber records.

Rule Actions

Rule actions are also taken from the Rule attribute dictionary 214 and represent values that will be returned in the response messages or behavioral triggers used to dictate message flows.

Rule actions are composed of the following parts:
action attribute—a name from the Rule attribute dictionary 214
value type—depends on the attribute definition, and can be an integer, string, or enum
data—the name-value pair that the rule engine generates in response to the successfully evaluated condition.

At rule compilation time the entire collection of rules is available for consideration. In particular the collection of rules may be parsed into groups of rules which have corresponding conditions. Then, a hash calculation formed from the conditions may be determined which distinguishes the groups from each other. Calculating the hash for an incoming request will determine entire groups of rules to be avoided.

The optimization method does the following:
For every rule table, identify groups of rule conditions that are reasonably repetitive—i.e. present in many rules in the table.
For each respective group of the identified groups, determine a hash function that will effectively summarize in a condensed form the set of criteria, operations and values that distinguish the group.
For each row of the rule table, calculate hash values per the hash functions identified previously.
For the compiled version of the rule table, store the derived hash functions and calculated hash values in memory when loading, in addition to the rules.

At run time, that is, when the rule engine is invoked and accesses the compiled version of the rule table, the following method is used:
For each rule engine invocation involving this rule table, calculate the hash values using the respective hash functions associated with the rule table.
When evaluating the rule table, skip all rows whose hash values are different from the calculated invocation hash values.

In the majority of the rule table evaluations, the hash will discriminate rules that are irrelevant to the conditions for which the rule engine was invoked and will result in zero or a minority of rules requiring specific evaluation thus significantly improving rule engine performance.

The following example will further illustrate the operation of an optimization method in accordance with an embodiment of the invention, but is not intended to be limiting.

Referring to Table 1 there may be seen a rule table have a set of Attribute-Value Pairs (AVPs) from AVP₁ to AVP₅. Also, there may be seen a Action which is to be taken when the Attributes correspond to the AVP value designated. The possible actions are A₁, A₂, and A₃(default). In operation, each row of Table 1 defines a rule. If the all the attributes correspond to the specific AVP value designated in the respective cell entry for that row, then the rule is satisfied and the designated action is indicated. In the event that none of the rules are satisfied, then the default action A₃ is indicated.

TABLE 1

| AVP₁ | AVP₂ | AVP₃ | AVP₄ | AVP₅ | Action |
|---|---|---|---|---|---|
| 1 | 2 | 3 | 4 | 5 | A₁ |
| 1 | 2 | 3 | 4 | 6 | A₁ |
| 1 | 2 | 3 | 4 | 7 | A₁ |
| 1 | 2 | 3 | 4 | 8 | A₁ |
| 1 | 2 | 3 | 4 | 9 | A₂ |
| 1 | 2 | 3 | 4 | 10 | A₂ |
| 1 | 2 | 3 | 4 | 11 | A₂ |
| 1 | 2 | 3 | 4 | 12 | A₂ |
| — | — | — | — | — | A₃ |
| | | | | | (Default) |

The following optimization groupings are discernable:

(1) If at least one of AVP₁ to AVP₅ isn't present in the incoming message, apply default action A₃.

(2) If (AVP₁≠1) or (AVP₂≠2) or (AVP₃≠3) or (AVP₄≠4) apply default action A₃.

(3) If [(AVP₁=1) AND (AVP₂=2) AND (AVP₃=3) AND (AVP₄=4)] AND [(AVP₅=5) OR (AVP₅=6) OR (AVP₅=7) OR (AVP₅=8)], apply action A₁.

(4) If [(AVP₁=1) AND (AVP₂=2) AND (AVP₃=3) AND (AVP₄=4)] AND [(AVP₅=9) OR (AVP₅=10) OR (AVP₅=11) OR (AVP₅=12), apply action A₂.

These groupings could be expressed as three different hashing functions which yield results Hash-code₁, Hash-code₂, and Hash-code₃ using, for example, the following codings:

integer function hash1 {
if ((AVP1==null) || (AVP2==null) || (AVP3==null) || (AVP4==null))
return 0;
else return 1;
}
integer function hash2 {
if ((AVP1==1) && (AVP2==2) && (AVP3==3) && (AVP4==4))
return 0;
else return 1;
}
integer function hash3 {
if ((AVP5==5) || (AVP5==6) || (AVP5==7) || (AVP5==8)) return 0;
else if ((AVP5==9) || (AVP5==10) || (AVP5==11) || (AVP5==12))
return 1;
else return 2;
}

Referring now to Table 2, there may be seen an expanded version of Table 1 with the results of the hash functions indicated.

With this approach, all three hash functions would be calculated for the supplied attributes when the rule engine is invoked.

TABLE 2

| | | | | | | Hash- | Hash- | Hash- |
|---|---|---|---|---|---|---|---|---|
| AVP₁ | AVP₂ | AVP₃ | AVP₄ | AVP₅ | Action₁ | code₁ | code₂ | code₃ |
| 1 | 2 | 3 | 4 | 5 | A1 | 1 | 0 | 0 |
| 1 | 2 | 3 | 4 | 6 | A1 | 1 | 0 | 0 |
| 1 | 2 | 3 | 4 | 7 | A1 | 1 | 0 | 0 |
| 1 | 2 | 3 | 4 | 8 | A1 | 1 | 0 | 0 |
| 1 | 2 | 3 | 4 | 9 | A2 | 1 | 0 | 1 |
| 1 | 2 | 3 | 4 | 10 | A2 | 1 | 0 | 1 |
| 1 | 2 | 3 | 4 | 11 | A2 | 1 | 0 | 1 |
| 1 | 2 | 3 | 4 | 12 | A2 | 1 | 0 | 1 |
| — | — | — | — | — | A3 | 0 | 1 | 2 |
| | | | | | (Default) | | | |

Alternatively, instead of three separate hash functions, a single “broad” hash function could be used. An example of a single broad hash function may be seen in the following coding:

integer function hash_Broad {
if ((AVP1==null) || (AVP2==null) || (AVP3==null) || (AVP4==null))
return 0;
else if ((AVP1 != 1) || (AVP2 != 2I) || (AVP3 != 3I) || (AVP4 != 4))
return 0;
else if ((AVP5==5) || (AVP5==6) || (AVP5==7) || (AVP5==8))
return 1;
else if ((AVP5==9) || (AVP5==10) || (AVP5==11) || (AVP5==12))
return 2;
else return 0;
}

Referring now to Table 3, there may be seen an expanded version of Table 1 with the results of the broad hash function indicated.

With this approach, a single hash value will be calculated for each rule table row.

TABLE 3

| AVP₁ | AVP₂ | AVP₃ | AVP₄ | AVP₅ | Action₁ | Broad-Hash-Code |
|---|---|---|---|---|---|---|
| 1 | 2 | 3 | 4 | 5 | A1 | 1 |
| 1 | 2 | 3 | 4 | 6 | A1 | 1 |
| 1 | 2 | 3 | 4 | 7 | A1 | 1 |
| 1 | 2 | 3 | 4 | 8 | A1 | 1 |
| 1 | 2 | 3 | 4 | 9 | A2 | 2 |
| 1 | 2 | 3 | 4 | 10 | A2 | 2 |
| 1 | 2 | 3 | 4 | 11 | A2 | 2 |
| 1 | 2 | 3 | 4 | 12 | A2 | 2 |
| — | — | — | — | — | A3 | 0 |
| | | | | | (Default) | |

Contemplated embodiments of the invention also include a number of techniques that can be used to identify optimal hash functions. Optimal assessments could vary from one individual installation of PCRF to another, and providing a variety of hash function determinations allows for optimizations of vastly different rule stores.

One group of techniques is concerned with rule compile-time optimization. This group includes:
Criteria presence consideration: if a significant portion of the rules in the table require presence of some data (e.g. a particular AVP) in the message data set to be present, then a hash function can very quickly weed out the messages that don't have them. Essentially, presence/absence is one of the easiest to implement hashing functions.
Mutually exclusive rules: a method of splitting all rule rows into two groups, only one of which needs to be considered for any given rule engine invocation.
Number of criteria consideration: if the determined hash function uses only a small portion of criteria used in the table, it may not be very useful at reducing run-time rule evaluation because of the extra computation costs of the hash calculation.
Criteria operations: an exact match operation is easier to hash/match than, for example a criteria such as “contains a string” or “greater than”).
Rule table length consideration: —short rule tables, for example, tables with less than about 10 rules, may be better served not using hash functions to segment run-time calculations because of the brevity of the table.
Multi-table considerations: looking beyond a single table to determine that selection of a relevant subset of rules in one rule table means also narrowing down the set of other tables (or rules in them) to consider.

Another group of techniques is concerned with run-time optimization. This group includes:
“Try both ways and compare” statistics: this is a run-time self-optimization where the results of both un-optimized and optimized versions are contrasted to determine the gains provided by the hashing.
Performance Statistics Retention: keeping statistics of the hash results match/mismatch to determine hash functions that work well or should be abandoned.

According to the foregoing, various exemplary embodiments provide for the optimization of rule engine behavior by application of hash functions which reduce the number of rules which require assessment at run-time. Particularly, by providing alternative methods for determining what hash function determinations should be applied in response to the specific rule sets extant at a particular PCRF installation, an operator may optimize how the rule engine responds.

It is to be understood that various changes in the details, materials, and arrangements of the parts which have been described and illustrated in order to explain the nature of this invention may be made by those skilled in the art without departing from the scope of the invention as expressed in the following claims.

It should also be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.” Numerous modifications, variations and adaptations may be made to the embodiment of the invention described above without departing from the scope of the invention, which is defined in the claims.

What is claimed is:

1. A method for accelerating the evaluation of rule tables within the compiled rule base for a rule engine; said method comprising the steps of:
identifying groups of repetitive rule conditions within a rule table within the rule base;
determining a first hash function which distinguishes said groups of rule conditions;
calculating respective hash values per said first hash function for each rule of said rule table;
storing said first hash function in said compiled rule base;
storing said respective hash values in said compiled rule base; and
storing said rule tables in said compiled rule base.

2. A method as claimed in claim 1, comprising the further step of
when said rule engine is invoked to determine at least one action for a set of attributes,
calculating the hash value for said set of attributes; and
skipping evaluation of those rows in said rule tables whose respective hash values are different than said hash value for said set of attributes.

3. A method as claimed in claim 1, further comprising the steps of:
determining at least one additional hash function which further distinguishes said groups of rule conditions; and
using said at least one additional hash function in said calculation and said storing steps.

4. A method as claimed in claim 3, further comprising the steps of:
when said rule engine is invoked to determine at least one action for a set of attributes,
calculating a first hash value for said set of attributes according to said first hash function;
calculating a second hash value for said set of attributes according to said at least one additional hash function; and
skipping evaluation of those rows in said rule tables whose respective hash values are different than said respective hash values for said set of attributes.

5. A method as claimed in claim 1, wherein said determining step further comprises a compile-time optimization for choosing said first hash function.

6. A method as claimed in claim 5, wherein said compile-time optimization comprises a criteria presence optimization.

7. A method as claimed in claim 5, wherein said compile-time optimization comprises a mutually exclusivity optimization.

8. A method as claimed in claim 5, wherein said compile-time optimization comprises a quantity of criteria used by said first hash function optimization.

9. A method as claimed in claim 5, wherein said compile-time optimization comprises a type of criteria used by said first hash function optimization.

10. A method as claimed in claim 5, wherein said compile-time optimization comprises a rule table length optimization.

11. A method as claimed in claim 5, wherein said compile-time optimization comprises a multi rule table optimization.

12. A method as claimed in claim 1, wherein said determining step further comprises a post run-time optimization for choosing said first hash function.

13. A method as claimed in claim 12, wherein said post run-time optimization comprises an optimization which contrasts a compiled rule base without said first hash function to a compiled rule base with said first hash function.

14. A method as claimed in claim 12, wherein said post run-time optimization comprises an optimization which contrasts a plurality of said first hash functions.

15. A method as claimed in claim 3, wherein said determining steps further comprises a compile-time optimization for choosing said first hash function and said at least one additional hash function.

16. A method as claimed in claim 15, wherein said compile-time optimization comprises a criteria presence optimization.

17. A method as claimed in claim 15, wherein said compile-time optimization comprises a mutually exclusivity optimization.

18. A method as claimed in claim 15, wherein said compile-time optimization comprises a quantity of criteria used by said first hash function optimization.

19. A method as claimed in claim 15, wherein said compile-time optimization comprises a type of criteria used by said first hash function optimization.

20. A method as claimed in claim 15, wherein said compile-time optimization comprises a rule table length optimization.

21. A method as claimed in claim 15, wherein said compile-time optimization comprises a multi rule table optimization.

22. A method as claimed in claim 3, wherein said determining step further comprises a post run-time optimization for choosing said first hash function and said at least one additional hash function.

23. A method as claimed in claim 22, wherein said post run-time optimization comprises an optimization which contrasts a compiled rule base without said first hash function to a compiled rule base with said first hash function.

24. A method as claimed in claim 22, wherein said post run-time optimization comprises an optimization which contrasts a plurality of said first hash functions.
